(19) United States
(12) Patent Application Publication
(10) Pub. No.: US 2018/0172064 A1
(43) Pub. Date: Jun. 21, 2018

(54) METHOD FOR MANUFACTURING CRANKSHAFT, AND CRANKSHAFT

(71) Applicants: TOYOTA JIDOSHA KABUSHIKI KAISHA, Toyota-shi (JP); MEG Inc., Anjo-shi (JP)

(72) Inventors: Koichi ONO, Toki-shi (JP); Yoshihiko UKAI, Nagoya-shi (JP); Keiichi MATSUNAGA, Anjo-shi (JP)

(73) Assignees: TOYOTA JIDOSHA KABUSHIKI KAISHA, Toyota-shi (JP); MEG Inc., Anjo-shi (JP)

(21) Appl. No.: 15/819,462

(22) Filed: Nov. 21, 2017

(30) Foreign Application Priority Data
Dec. 20, 2016 (JP) 2016-246796

(51) Int. Cl. F16C 3/08; F16F 15/26; B21D 22/02; B21K 1/08

(52) U.S. Cl. CPC F16C 3/08; B21K 1/08; B21D 22/02; F16F 15/26

(57) ABSTRACT

A method for manufacturing a crankshaft including a pin portion and a journal portion includes: a preparation process of preparing a die that is formed such that a parting plane of the pin portion and a parting plane of the journal portion are spaced apart from each other in a stamping direction; and a stamping process of forming a shaft portion including the pin portion and the journal portion by stamping a blank with the die.

### INCORPORATION BY REFERENCE

The disclosure of Japanese Patent Application No. 2016-246796 filed on Dec. 20, 2016 including the specification, drawings and abstract is incorporated herein by reference in its entirety.

### BACKGROUND

### 1. Technical Field

The disclosure relates to a method for manufacturing a crankshaft, and a crankshaft.

### 2. Description of Related Art

Die forging is widely used as a method for manufacturing a crankshaft (see, for example, International Publication No. 09/004738). In the process of die forging, a rod-like carbon steel as a blank is sandwiched and stamped between an upper die and a lower die, for example. FIG. 10 is a view useful for explaining a stamping process for production of a crankshaft according to a method of the related art. A crankshaft 900 formed by this method has a journal portion 913, arm portion 914, pin portion 915, arm portion 914, journal portion 913, . . . , which are successively arranged along the axial direction, and forms a crank structure in which the pin portions 915 are located ahead of the plane of the paper, or located behind the plane of the paper, relative to the journal portions 913 assumed to be located on the plane of the paper. Then, counter weight portions 919 protrude from the arm portions 914 toward one side of the journal portions 913 opposite to the pin portions 915.

A metal mold or die used when the crankshaft 900 is formed by stamping is divided into an upper die and a lower die, and a parting plane of the upper die and the lower die is provided by a plane represented by a dotted line in FIG. 10, which divides the journal portions 913, arm portions 914, pin portions 915, and the counter weight portions 919, into upper and lower sections that are symmetrical in the vertical direction. Namely, the crankshaft 900 is formed by stamping in a direction perpendicular to the crank plane.

### SUMMARY

The die structure can be simplified if it has the upper die and the lower die parted along the flat plane, as described above. However, where the rod-like blank is stamped and forged in the above manner, the pin portions and their vicinities, and the bases of the counter weight portions, which are particularly required to have high rigidity, may not be sufficiently forged, since the stamping direction is perpendicular to the fiber flow direction. Also, the forging ratio as the ratio at which the blank is deformed in the stamping direction is small, which is disadvantageous in terms of improvement of the rigidity.

This disclosure provides a method for manufacturing a crankshaft such that each pin portion and its vicinity, and a base of each counter weight portion, which are particularly required to have high rigidity, are sufficiently forged, and also provides a crankshaft having a favorable configuration when the manufacturing method is employed.

As an aspect of the disclosure includes a method for manufacturing a crankshaft including a pin portion and a journal portion. The method includes: a preparation process of preparing a die that is formed such that a parting plane of the pin portion and a parting plane of the journal portion are spaced apart from each other in a stamping direction; and a stamping process of forming a shaft portion including the pin portion and the journal portion by stamping a blank with the die.

According to the stamping process as described above, stamping is performed with a so-called crank plane situated vertically, so that the forging ratio can be increased. Also, the blank can be forged at the pin portion and its vicinity and the base of a counter weight portion, along the fiber flow direction of the blank. Accordingly, the rigidity of the pin portion and its vicinity, and the base of the counter weight portion, which are likely to be influenced by an explosive load during use, can be increased.

The crankshaft manufacturing method may further include a counter weight forming process for forming the counter weight portion as a separate body, and a mounting process of mounting the counter weight portion on the shaft portion. If the counter weight forming process and the mounting process are added, there is no need to form the shaft portion integrally with the counter weight portion in the stamping process. With the counter weight portion thus formed as a separate body, the counter weight portion need not be shaped such that its functionality is sacrificed, even in the case where stamping is performed with the clank plane situated vertically.

Namely, the die needs to be provided with tapered faces that are open to a parting plane(s) for mold release; therefore, if the shaft portion is formed integrally with the counter weight portion, the counter weight portion is shaped so as to be narrowed in a radial direction away from the journal portion. The counter weight portion is preferably shaped such that its mass is unevenly distributed to be large at a position farthest from the journal portion as the axis of rotation. This preferred arrangement cannot be attained if the counter weight portion is formed integrally on the shaft portion. However, if the counter weight portion is formed as a separate body, it is not subjected to restrictions due to the use of the die, and therefore, the counter weight portion can be shaped such that its mass is unevenly distributed to be large at a position far from the journal portion.

Also, the mounting process may include a caulking process for engaging a shaft-side engaging portion formed on the shaft portion by the stamping process, with a counter weight-side engaging portion formed by the counter weight forming process, and caulking the shaft-side engaging portion and the counter weight-side engaging portion together. In the case where the shaft portion and the counter weight portion as separate members are joined together, there is a possibility that these separate members are detached from each other or loosened, due to centrifugal force, or the like, during use of the crankshaft. However, when the shaft portion and the counter weight portion are integrated by caulking, this possibility can be reduced.

The crankshaft manufacturing method may further include an additional working process after the stamping process and before the mounting process, of additionally processing the shaft-side engaging portion such that the shaft-side engaging portion includes a receiving face that receives centrifugal force acting on the counter weight portion during use of the crankshaft. The additional working process may include processing a shape of the shaft-side engaging portion such that the shaft-side engaging portion is at least one of inverted triangular shape, fan-shaped or sectoral, and T-shaped. With the receiving face thus provided, the shaft-side engaging portion fulfills a function of keeping the counter weight portion close to the shaft portion, even if centrifugal force is applied to the counter weight portion, during use of the crankshaft. Accordingly, even if the counter weight portion is provided as a separate body, the counter weight portion is less likely or unlikely to wobble relative to the shaft portion or to be moved away from the shaft portion, due to vibrations, or the like, during use.

When the shaft portion provided with an even number of the pin portions and a plurality of the journal portions arranged in an axial direction of the shaft portion is formed in the stamping process, the shaft-side engaging portions may be provided at opposite end portions of a centrally placed journal portion as one of the plurality of journal portions, and the shaft-side engaging portions may be not provided at the journal portions located next to the centrally placed journal portion. If the counter weight portion is formed as a separate body, its shape can be optimized; therefore, a reduced number of counter weight portions can deliver performance equivalent to or greater than that of known plural counter weight portions. Also, if the shaft-side engaging portions are provided at the opposite end portions of the centrally placed journal portion, and the counter weight portions are mounted thereon, the required performance can be more efficiently satisfied.

As an aspect of the disclosure includes a crankshaft comprising: a shaft portion including a pin portion and a journal portion, and including a shaft-side engaging portion; a counter weight portion mounted on the shaft portion, and including a counter weight side engaging portion; the shaft portion and the counter weight portion being integrated with each other, such that the shaft-side engaging portion engages with the counter weight side engaging portion; and the shaft-side engaging portion including a receiving face that receives centrifugal force of the counter weight portion applied from the shaft portion in a radial direction.

In the crankshaft constructed as described above, the shapes of the counter weight portion and the shaft portion can be respectively optimized. Also, the shaft-side engaging portion fulfills a function of keeping the counter weight portion close to the shaft portion, even if centrifugal force is applied to the counter weight portion during use of the crankshaft, so that the counter weight portion is less likely or unlikely to wobble relative to the shaft portion or to be moved away from the shaft portion.

A shape of the shaft-side engaging portion may be at least one of inverted triangular shape, fan-shaped or sectoral, and T-shaped. With the above configuration, the shaft-side engaging portion fulfills a function of keeping the counter weight portion close to the shaft portion, even if centrifugal force is applied to the counter weight portion, during use of the crankshaft. Accordingly, even if the counter weight portion is provided as a separate body, the counter weight portion is less likely or unlikely to wobble relative to the shaft portion or to be moved away from the shaft portion, due to vibrations, or the like, during use.

According to this disclosure, it is possible to provide the method of manufacturing the crankshaft such that the rigidity of the crankshaft, in particular, that of the pin portion and its vicinity, and the base of the counter weight portion, can be increased, and also provide the crankshaft having a favorable configuration when the above manufacturing method is employed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of a crankshaft as a completed product according to one embodiment of the disclosure;

FIG. 2 is a view useful for explaining a stamping direction of a shaft portion and a die;

FIG. 3A is a view useful for explaining a preforming process;

FIG. 3B is a view useful for explaining a preforming process;

FIG. 4A is a view useful for explaining a stamping process;

FIG. 4B is a view useful for explaining a stamping process;

FIG. 4C is a view useful for explaining a stamping process;

FIG. 5 is an A-A cross-sectional view of a shaft portion;

FIG. 6A is a B-B cross-sectional view of the shaft portion;

FIG. 6B is a B-B cross-sectional view of the shaft portion;

FIG. 7A is a view useful for explaining a counter weight portion;

FIG. 7B is a view useful for explaining a counter weight portion;

FIG. 8A is a view useful for explaining a mounting process;

FIG. 8B is a view useful for explaining a mounting process;

FIG. 9 is an entire flow diagram of a manufacturing process; and

FIG. 10 is a view useful for explaining a stamping process for production of a crankshaft according to a method of the related art.

### DETAILED DESCRIPTION OF EMBODIMENTS

While this disclosure will be described through one embodiment of the disclosure, the description is not intended to limit the disclosure as defined in the appended claims to the following embodiment.

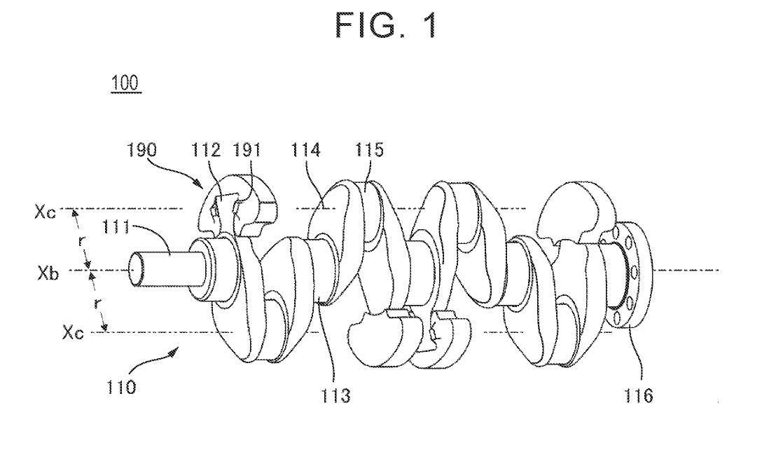

FIG. 1 shows the overall structure of a crankshaft 100 as a completed product according to this embodiment. The crankshaft 100 that has gone through a manufacturing process that will be described later is constructed such that counter weight portions 190 formed as separate bodies are mounted on a shaft portion 110.

The shaft portion 110 of the crankshaft 100 has one end in the form of a drive shaft portion 111 coupled to a crankshaft pulley, for example, and the other end in the form of a flywheel mounting portion 116 to which a flywheel is connected. The axis of rotation Xb of the shaft portion 110 is represented by a straight line that connects the center of the drive shaft portion 111 with the center of the flywheel mounting portion 116, and the shaft portion 110 includes a plurality of journal portions 113 arranged along the rotation axis Xb. Two adjacent ones of the journal portions 113 are connected by a set of two arm portions 114 and a pin portion 115 sandwiched therebetween.

Each of the journal portions 113 functions as a rotary shaft having the rotation axis Xb as the center of rotation, and may also be called “crank journal”. The pin portion 115 is a portion to which a big end of a connecting rod is connected, and may also be called “crank pin”. The pin portion 115 is a columnar shaft having a centerline Xc that is in parallel with the rotation axis Xb, and is spaced apart from the axis Xb by a certain distance r.

Each of the arm portions 114 is a connecting portion that connects one of the journal portions 113 and a corresponding one of the pin portions 115 having different centerlines, and may also be called “crank arm”. Some of the arm portions 114 are provided with shaft-side engaging portions 112. Each of the shaft-side engaging portions 112 is a protruding portion that extends in a radial direction with respect to the rotation axis Xb, from around a connecting portion of the arm portion 114 with the journal portion 113, in a direction generally opposite to the direction from the journal portion 113 toward the pin portion 115.

The journal portions 113, arm portions 114, and the pin portions 115 are formed integrally from a single rod-like blank as will be described later, along with the drive shaft portion 111 and the flywheel mounting portion 116. On the other hand, the counter weight portions 190 are formed as separate members. The counter weight portions 190 function to prevent vibrations, etc. by equalizing the imbalance of the crankshaft 100, and may be called “balance weights”. Each of the counter weight portions 190 has a counter weight side engaging portion (CW-side engaging portion) 191 formed in a concave shape, for engagement with the corresponding shaft-side engaging portion 112. With the shaft-side engaging portions 112 and the CW-side engaging portions 191 engaging with each other, the counter weight portions 190 are secured to and integrated with the shaft portion 110.

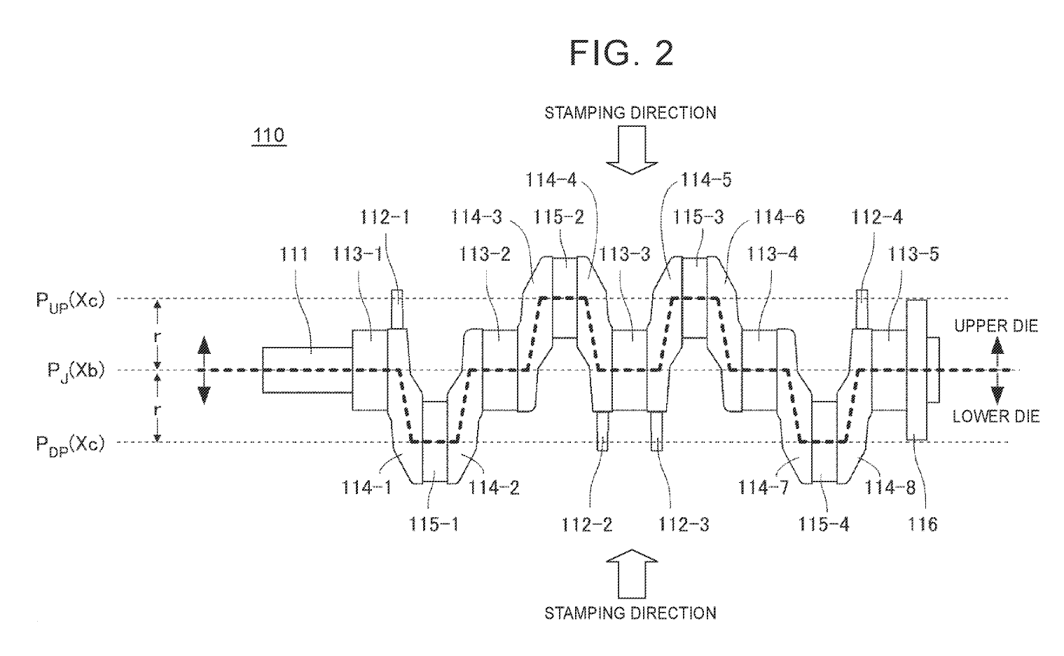

FIG. 2 is a view useful for explaining the stamping direction of the shaft portion 110 and dies or metal molds. FIG. 2 shows the shaft portion 110 that has been subjected to stamping, as viewed in a direction facing a side face of the shaft portion 110.

The crankshaft 100 according to this embodiment is used for a four-cylinder engine, and the shaft portion 110 has four pin portions 115 (115-1 to 115-4). Among the pin portions 115, a pin portion 115-1 located closest to the drive shaft portion 111 and a pin portion 115-4 located closest to the flywheel mounting portion 116 are spaced apart from the rotation axis Xb in the same direction (downward on the plane of paper of FIG. 2). Also, two pin portions 115-2, 115-3 located close to the center are placed on the same side of the rotation axis Xb, and are spaced apart from the rotation axis Xb in a direction (upward on the plane of paper of FIG. 2) opposite to that of the pin portions 115-1, 115-4.

The pin portion 115-1 is connected to the arm portion 114-1 on the drive shaft portion 111 side, and is connected to the arm portion 114-2 on the flywheel mounting portion 116 side, and the pin portion 115-1 is spaced apart from the rotation axis Xb, such that it is sandwiched between the two arm portions 114-1, 114-2. Similarly, the pin portion 115-2 is connected to the arm portions 114-3, 114-4, and the pin portion 115-3 are connected to the arm portions 114-5, 114-6, while the pin portion 115-4 is connected to the arm portions 114-7, 114-8. Each of the pin portions 115-2, 115-3, 115-4 is spaced apart from the rotation axis Xb.

The shaft portion 110 includes five journal portions 113 (113-1 to 113-5), which are arranged along the rotation axis Xb. The journal portion 113-1 is located between the drive shaft portion 111 and the arm portion 114-1, and the journal portion 113-2 is located between the arm portions 114-2, 114-3, while the journal portion 113-3 is located between the arm portions 114-4, 114-5, and the journal portion 113-4 is located between the arm portions 114-6 and 114-7. The journal portion 113-5 is located between the arm portion 114-8 and the flywheel mounting portion 116.

The shaft-side engaging portions 112 are provided at four locations. More specifically, the shaft-side engaging portion 112-1 is provided on the arm portion 114-1, and the shaft-side engaging portion 112-2 is provided on the arm portion 114-4, while the shaft-side engaging portion 112-3 is provided on the arm portion 114-5, and the shaft-side engaging portion 112-4 is provided on the arm portion 114-8. Namely, no shaft-side engaging portions 112 are provided on the remaining four arm portions 114 (114-2, 114-3, 114-6, 114-7).

The shaft-side engaging portions 112-1, 112-4 protrude upward on the plane of paper of FIG. 2. On the other hand, the shaft-side engaging portions 112-2, 112-3 protrude downward on the plane of paper. Namely, the counter weight portions 190 are mounted such that the mass of each of the counter weights is eccentrically located. Thus, the counter weight portions 190 may be mounted on only some of the arm portions 114, because the counter weight portions 190 are formed as separate bodies. Namely, the counter weight portions 190 can freely employ any shape without being restricted by the dies used for forming the shaft portion 110; therefore, the capability of reducing the inertia force can be enhanced, as compared with known counter weight portions.

In the case where the number of the counter weight portions can be reduced, it is preferable that the shaft-side engaging portions 112-2, 112-3 are provided at the opposite ends of the center journal portion 113-3, and the shaft-side engaging portions 112 are not provided at the journal portions 113-2, 113-4 located next to the journal portion 113-3. Generally, in a crankshaft for an even number of cylinders, adjacent two pin portions (pin portions 115-2, 115-3 in the example of FIG. 2) between which a centrally placed journal portion (journal portion 113-3 in the example of FIG. 2) is sandwiched are located in the same phase. Therefore, vibrations of the centrally placed journal portion tend to be large, and it is preferable to locate counter weight portions close to the journal portion, so as to suppress the vibrations. Namely, when an even number of pin portions are provided on the shaft portion of the crankshaft for the even number of cylinders, it is preferable that the shaft-side engaging portions are provided at the opposite end portions of the centrally placed journal portion, among the plurality of journal portions arranged in the axial direction of the shaft portion, and no shaft-side engaging portions are provided at the journal portions located next to the above-indicated central journal portion.

Since the shaft-side engaging portions 112-2, 112-3 protrude in the same direction, the two counter weight portions 190 mounted on these portions are located on the same side. Thus, the counter weight portions 190 located on the opposite side are preferably provided on the arm portions 114-1, 114-8 that are located at the ends. Thus, in this embodiment, the shaft-side engaging portions 112-1, 112-4 are provided on the arm portions 114-1, 114-8. With the counter weight portions 190 thus mounted at these positions, it is possible to appropriately reduce the inertia force generated due to motion of the connecting rod, and also suppress or reduce the overall vibrations generated in the axial direction, in a balanced manner.

In this embodiment, the shaft portion 110 is stamped by use of an upper die and a lower die that are separate at parting planes perpendicular to the plane of paper along thick dotted lines in FIG. 2. Namely, the shaft portion 110 is stamped in a condition where a flat plane containing broken lines (=thick dotted lines) that appear when the centers of the respective elements are connected as shown in FIG. 2, or a so-called crank plane, is set up vertically.

In the journal portions 113, the parting plane is a flat plane perpendicular to the stamping direction and including the rotation axis Xb. In the pin portions 115, the parting plane is a flat plane perpendicular to the stamping direction and including the centerline Xc. In the arm portions 114, the parting plane is a flat plane that connects the parting plane of the corresponding journal portion 113 and the parting plane of the corresponding pin portion 115. Accordingly, as shown in FIG. 2, the parting planes of the pin portions 115 and the journal portions 113 are spaced apart from each other in the stamping direction.

More specifically, where the parting plane P_{J} of the journal portions 113 is regarded as a reference plane of the upper die and the lower die, the parting plane P_{UP} shared by the pin portions 115-2, 115-3 is provided by digging corresponding portions of the upper die in the depth direction, and projecting corresponding portions of the lower die. Similarly, the parting plane P_{DP} shared by the pin portions 115-1, 115-4 is provided by digging corresponding portions of the lower die in the depth direction, and projecting corresponding portions of the upper die.

Since the shaft portion 110 of this embodiment has no counter weight portion, it is easy to fabricate a metal mold or die having this structure, which requires only reasonable effort to set tapered faces for release of the mold. Namely, even if such three-dimensional parting planes are set, it is possible to fabricate an upper die and a lower die that are free from undercuts.

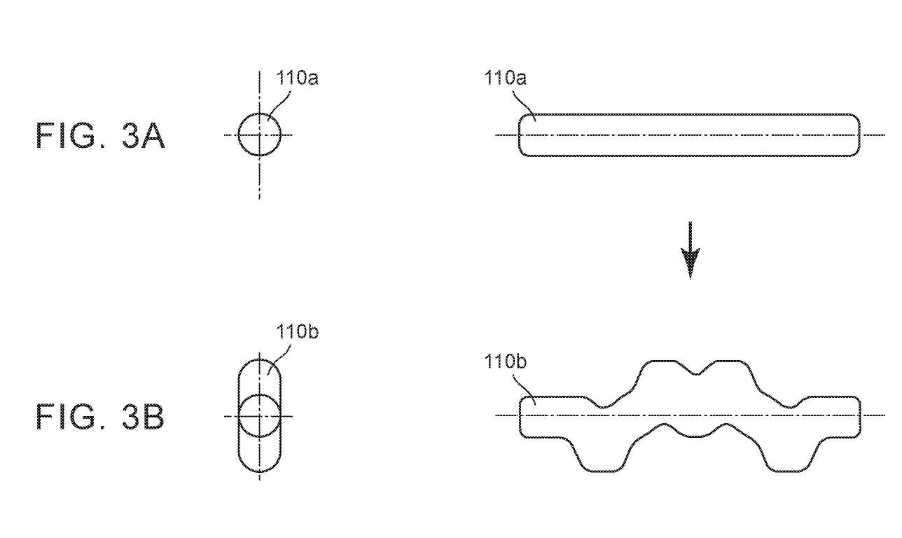

Next, main processes or steps of the process for manufacturing the crankshaft 100 will be sequentially described. FIG. 3A and FIG. 3B are views useful for explaining a preforming process. FIG. 3A is a set of a front view and a side view of a rod-like blank 110a obtained through a cutting process for cutting a columnar billet to a certain length. The rod-like blank 110a is formed of a special steel, such as carbon steel or chrome molybdenum steel. Also, fiber flow lines extend along the axial direction of the rod-like blank 110a.

FIG. 3B is a set of a front view and a side view of a preformed blank 110b obtained through the preforming process. In the preforming process, the rod-like blank 110a of FIG. 3A is heated to a certain temperature equal to or higher than 1200° C., for example, and subjected to bending, or the like, so as to provide the preformed blank 110b having a shape somewhat close to the shape of the shaft portion 110.

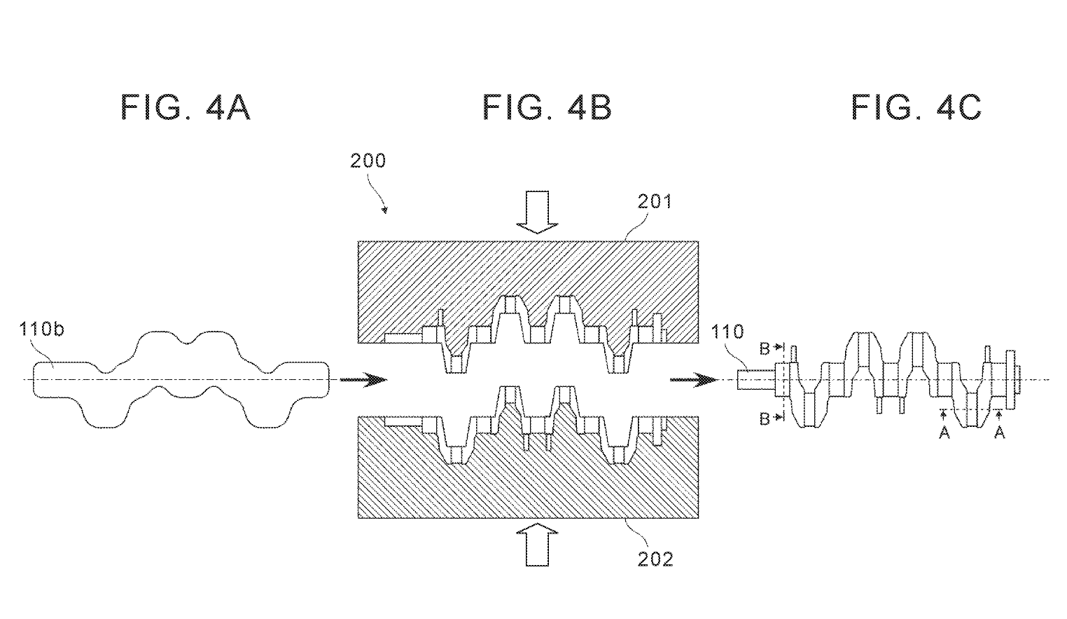

FIG. 4A-FIG. 4C are views useful for explaining a stamping process. FIG. 4A shows the preformed blank 110b obtained in FIG. 3B. FIG. 4B is a center cross-sectional view of a die 200. FIG. 4C shows the shaft portion 110 formed by using the die 200.

In the stamping process, the preformed blank 110b is placed in the die 200 set in a forging device, and die forging is performed. The die 200 consists of the upper die 201 and the lower die 202, as described above. The preformed blank 110b is sandwiched between the upper die 201 and the lower die 202, and its shape is changed into that of the shaft portion 110. In FIG. 4A-FIG. 4C, the manner of forging with the die 200 is simplified and conceptually illustrated. However, in the actual process, the preformed blank 110b may be subjected to forming with two or more dies, starting from a rough forming step of die-forging the blank into a rough shape, to a finishing step of die-forging it into a final shape, with the accuracy successively enhanced. Also, a trimming process for removing flash is performed.

If stamping is performed with the crank plane vertically situated, the stamping direction generally coincides with the fiber flow direction of the shaft-side engaging portions 112 and the arm portions 114. Thus, these portions are particularly toughened, and their rigidity increases. As compared with known forging with the crank plane transversely situated, the amount of deformation in the stamping direction is increased, and the forging ratio is increased. In this point, too, the die forging of this embodiment is preferable in terms of increased rigidity of the above-indicated portions. In particular, the shaft-side engaging portions 112, on which the counter weight portions 190 are mounted, are subjected to explosive loads, such as centrifugal force, acting on the counter weight portions 190 during rotation of the crankshaft 100; therefore, it is considerably desirable that the shaft-side engaging portions 112 have greater rigidity.

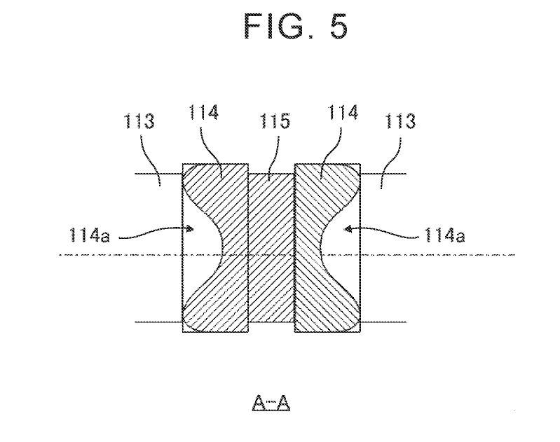

FIG. 5 is an A-A cross-sectional view of the shaft portion 110 shown in FIG. 4C. When the arm portions 114 on both sides of the pin portion 115 are observed from the downside, as shown in FIG. 5, it is understood that the arm portions 114 are respectively provided with thinned portions 114a formed in their surfaces opposite to those connected to the pin portion 115.

In the known stamping with the crank plane transversely situated, the arm portions cannot be subjected to thinning as described above, due to restrictions of tapered faces for release of the mold. Redundant thickness parts of the arm portions removed by thinning make no contribution to torsional rigidity of the crankshaft 100, but only results in increase of the overall weight. With regard to the die 200 used for stamping with the clank plane vertically situated as in this embodiment, no problem or inconvenience occurs to formation of tapered faces for release of the mold, even if the above thinned portions 114a are provided. Namely, the weight of the crankshaft 100 can be reduced by removing the redundant thickness parts. In particular, edge portions of the arm portions 114 are formed with the full thickness so as to bank the thinned portions 114a, such that the arm portions 114 as a whole assume an H-like cross-sectional shape (the shape of H rotated by 90 degrees in FIG. 5), and this cross-sectional shape contributes to improvement of the torsional rigidity.

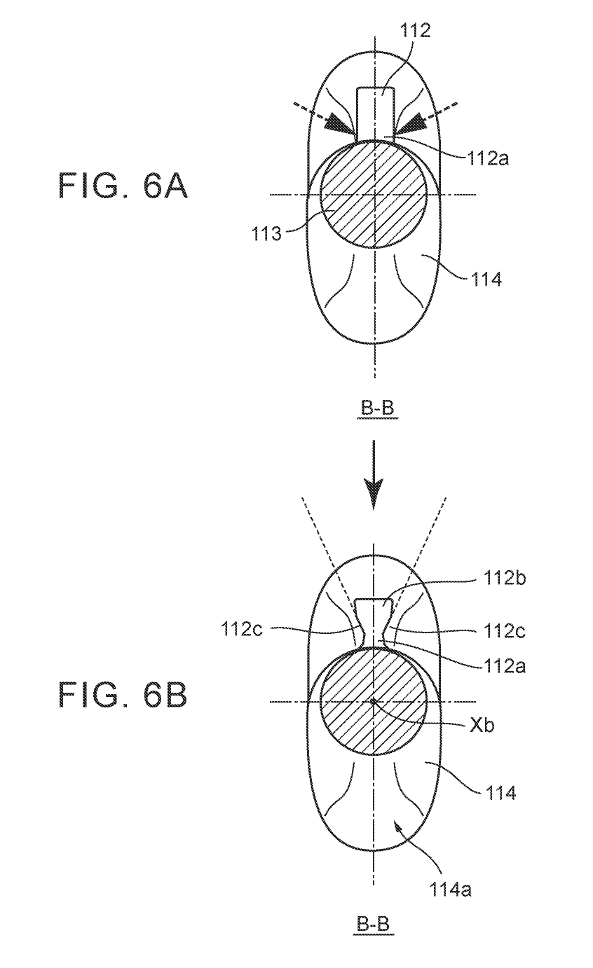

FIG. 6A and FIG. 6B are B-B cross-sectional views of the shaft portion 110 shown in FIG. 4C, which are useful for explaining an additional working process on each of the shaft-side engaging portions 112. FIG. 6A is a B-B cross-sectional view of the shaft portion 110 before additional working, and FIG. 6B is a B-B cross-sectional view of the shaft portion 110 after additional working.

In this embodiment, the shaft-side engaging portions 112 and the CW-side engaging portions 191 engage with each other, as described above, so that the shaft portion 110 and the counter weight portions 190 are integrated. At this time, the CW-side engaging portion 191 may be shaped so as to be engaged with the shaft-side engaging portion 112 that is not subjected to additional working, as shown in FIG. 6A. However, in the crankshaft 100 of this embodiment, the shapes of the engaging portions are improved, so that the crankshaft 100 can be rotated at a higher speed, and large-sized counter weight portions 190 can be mounted on shaft portion 110. More specifically, the vicinity of a connecting portion 112a, represented by dotted arrows in FIG. 6A, of the shaft-side engaging portion 112 with the arm portion 114 is additionally processed by cutting.

As shown in FIG. 6B, through additional working, the shaft-side engaging portion 112 is formed into a generally inverted triangular shape with its apex located on the connecting portion 112a side and its base located on a distal end portion 112b side. Namely, opposing slant faces 112c are provided which extend from the distal end portion 112b to the connecting portion 112a. The opposing slant faces 112c function to receive the centrifugal force acting on the counter weight portion 190, when the crankshaft 100 on which the counter weight portion 190 is mounted rotates. Namely, the opposing slant faces 112c fulfill a function of engaging the counter weight portion 190 that is moving away from the rotation axis Xb in a radial direction under the centrifugal force, with the CW-side engaging portion 191, and withholding or retaining the counter weight portion 190 toward the shaft portion. Accordingly, the opposing slant faces 112c reduce a possibility that the counter weight portion 190 wobbles against or moves away from the shaft portion 110 due to vibrations, or the like, during use, even if the counter weight portion 190 is provided as a separate body.

While the engaging portion is processed into a generally inverted triangular shape, and is provide with the opposing slant faces, in this embodiment, the shape of the engaging portion for receiving the centrifugal force is not limited to this shape. The engaging portion may be formed in any shape, provided that it has a slant face or faces having an angle that enables the face to receive centrifugal force acting in a radial direction from the rotation axis Xb. For example, the engaging portion may be fan-shaped or sectoral, or T-shaped.

The thinned portion 114a shown in FIG. 6B is one of the thinned portions 114a explained above with reference to FIG. 5 when observed from the front direction. While the opposite sides of the thinned portion 114a are raised so as to provide an H-shaped cross-section, in portions that contribute to improvement of the torsional rigidity, the arm portion 114 makes substantially no contribution to the torsional rigidity, in distal end portions corresponding to the opposite sides of the pin portion 115; therefore, large portions of the distal end portions are removed as redundant thickness parts.

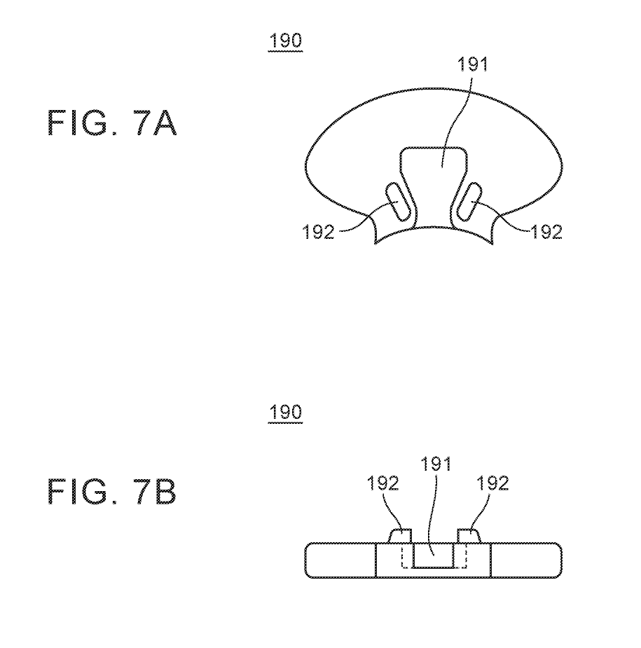

FIG. 7A and FIG. 7B are views useful for explaining each of the counter weight portions 190. FIG. 7A is a front view of the counter weight portion 190, and FIG. 7B is a bottom view of the counter weight portion 190. The overall shape of the counter weight portion 190 is determined, according to the specifications of the crankshaft 100, so that the inertia force can be appropriately reduced.

The counter weight portion 190 has the CW-side engaging portion 191 that engages with the shaft-side engaging portion 112. The CW-side engaging portion 191 is formed as a concave, bottomed groove. The counter weight portion 190 is provided, at its portions around the CW-side engaging portion 191, with caulking masses 192 that protrude from a surface of the portion 190.

The counter weight portion 190 may be formed of the same material as the shaft portion 110, or a material different from that of the shaft portion 110. In this embodiment, the counter weight portion 190 is formed as a separate body; therefore, a material having a higher density than the material of the shaft portion 110 may be employed. Also, the counter weight portion 190 is not necessarily formed by forging, but other processing methods may be employed. For example, the counter weight portion 190 may be formed by casting or press. If other processing methods are employed, the scope of options of the material can be further broadened.

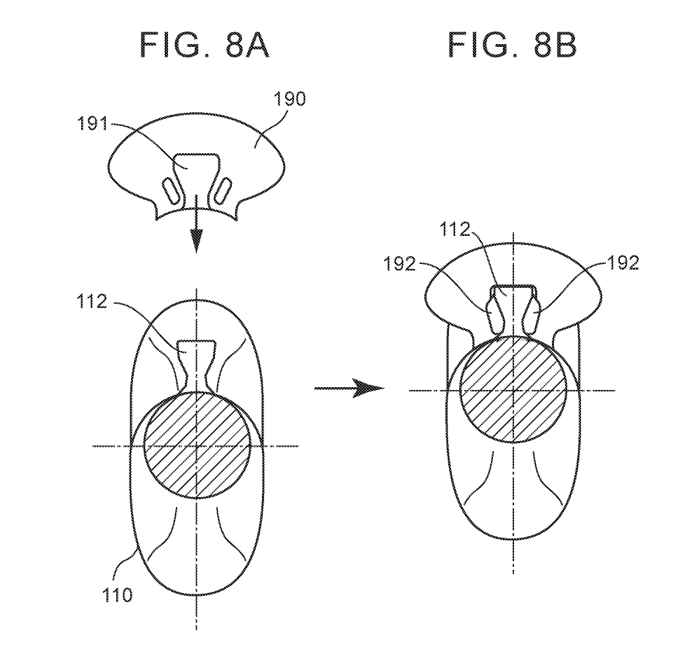

FIG. 8A and FIG. 8B are views useful for explaining a mounting process. FIG. 8A shows the manner of mounting the counter weight portion 190 on the shaft portion 110, and FIG. 8B shows the manner of caulking the counter weight portion 190 to the shaft portion 110.

As shown in FIG. 8A, in the mounting process, the counter weight portion 190 formed as a separate body is mounted on the shaft portion 110 in which the shaft-side engaging portion 112 has been additionally processed. More specifically, the shaft-side engaging portion 112 and the CW-side engaging portion 191 are engaged with each other. Since the CW-side engaging portion 191 is the bottomed groove as described above, positioning of the CW-side engaging portion 191 in the axial direction is achieved through surface alignment.

Next, a caulking process is performed as one step of the mounting process. The caulking process is a process of squashing the caulking masses 192. When the caulking masses 192 are squashed, a part of the masses flows into engagement clearances, and another part of the masses covers surfaces of the shaft-side engaging portion 112. As a result, the counter weight portion 190 is surely secured to the shaft portion 110, without wobbling in the axial direction and radial direction.

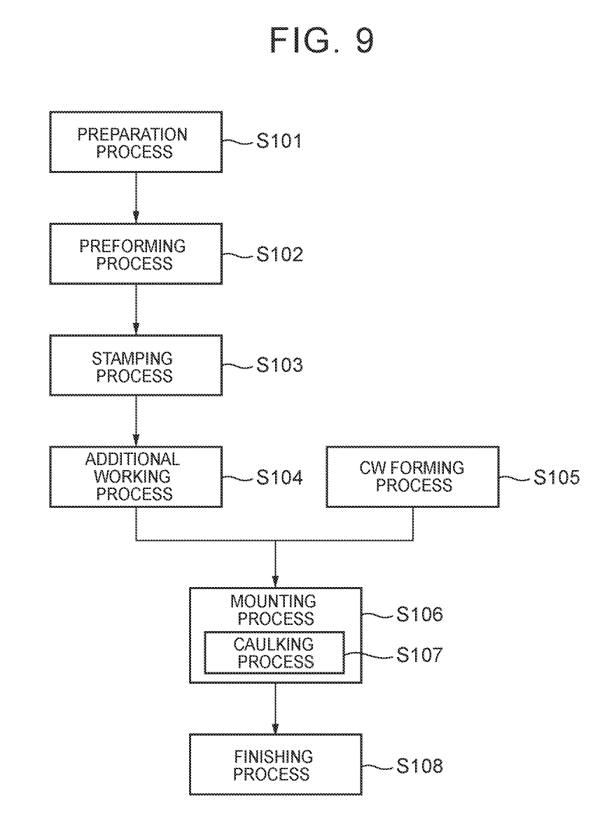

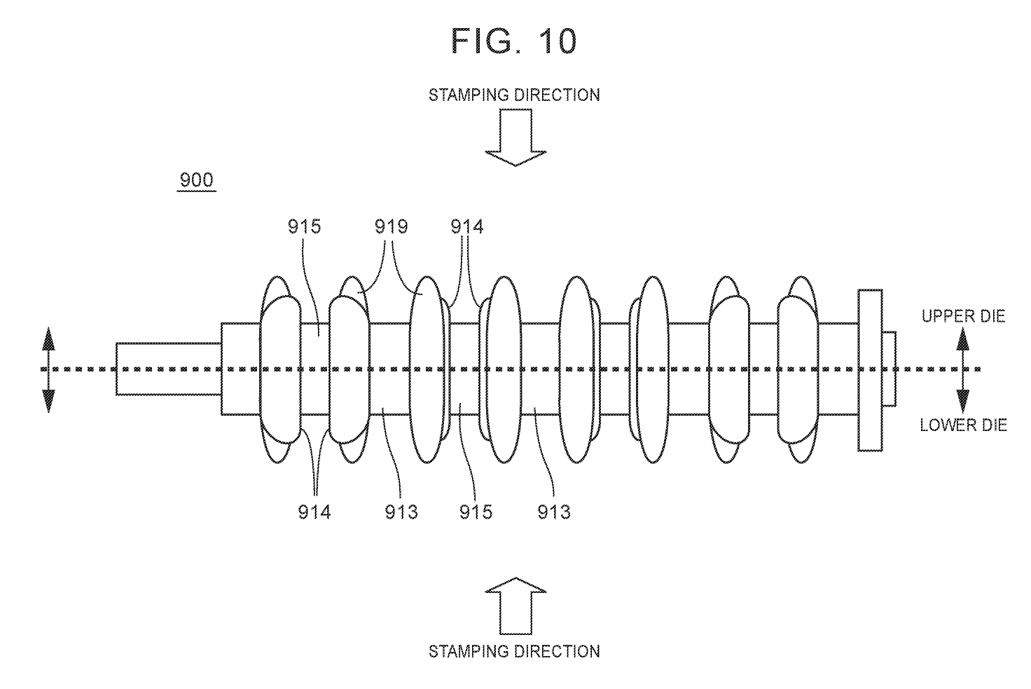

Next, the manufacturing process of the crankshaft 100 will be simply summarized. FIG. 9 is an entire flow diagram of the manufacturing process.

As a process for forming the shaft portion 110, a preparation process is initially carried out (step S101). The preparation process includes a cutting process for cutting a columnar billet whose fiber flow extends in the axial direction, to a certain length. Next, the preforming process is carried out (step S102). The preforming process is a process for obtaining the preformed blank 110b through bending, or the like, as described above using FIG. 3A and FIG. 3B.

Next, the stamping process is carried out (step S103). The stamping process is a process for stamping the preformed blank 110b, so as to form the shaft portion 110, as described above using FIG. 4A-FIG. 4C. The stamping process may include a rough forming step of die-forging the blank into a rough shape, and a finishing step of die-forging the roughly formed work into a final shape. Also, a trimming process for removing flash, a surface treatment process for performing surface treatment, a cooling process for removing heat, etc. may be selectively added as needed.

After the stamping process is finished, the additional working process explained above using FIG. 6A and FIG. 6B is carried out (step S104). The additional working process is a process for providing the shaft-side engaging portion 112 with a receiving faces that receive the centrifugal force acting on the counter weight portion 190 during use.

In the meantime, a CW forming process for forming the counter weight portion 190 as a separate body is carried out (step S105). In the CW forming process, the profile or outline of the counter weight portion 190 is formed, and the CW-side engaging portion 191 is formed as a bottomed groove.

In the mounting process, the counter weight portion 190 formed in the CW forming process is mounted on the shaft portion 110 obtained through the additional working process (step S106). The mounting process includes the caulking process. In the caulking process, the caulking masses 192 are squashed, so that the counter weight portion 190 is secured to the shaft portion 110. After the mounting process is completed, a finishing process for performing cutting or grinding on parts required to be cut or ground is performed (step S108), and the crankshaft 100 is completed.

While the crankshaft 100 as described above is used for the four-cylinder engine, crankshafts for engines other than four-cylinder engines may be manufactured by substantially the same manufacturing process. The number and location or arrangement of the counter weight portions 190 may be respectively optimized. While the crankshaft 100 as described above has various features as described above, crankshafts that selectively employ a particular feature or features may be manufactured. For example, since stamping with the crank plane vertically situated is effective in terms of improvement of the rigidity, this feature may be employed in the case where the counter weight portion and the shaft portion are formed integrally as a unit. Also, the caulking process may be replaced with a welding process for welding the shaft-side engaging portion 112 and the CW-side engaging portion 191 together.

While a hot forging process for heating and forging the blank is employed, in the manufacturing process as described above, a cold forging process for forging the blank without heating it may be employed provided that certain conditions concerning the blank, forging ratio, etc. are satisfied.

What is claimed is:

1. A method for manufacturing a crankshaft including a pin portion and a journal portion, the method comprising:
a preparation process of preparing a die that is formed such that a parting plane of the pin portion and a parting plane of the journal portion are spaced apart from each other in a stamping direction; and
a stamping process of forming a shaft portion including the pin portion and the journal portion by stamping a blank with the die.

2. The method according to claim 1, further comprising:
a counter weight forming process of forming a counter weight portion as a separate body; and
a mounting process of mounting the counter weight portion on the shaft portion.

3. The method according to claim 2, wherein the mounting process includes a caulking process of engaging a shaft-side engaging portion formed on the shaft portion by the stamping process, with a counter weight side engaging portion formed by the counter weight forming process, and caulking the shaft-side engaging portion and the counter weight side engaging portion together.

4. The method according to claim 3, further comprising an additional working process after the stamping process and before the mounting process, of additionally processing the shaft-side engaging portion such that the shaft-side engaging portion includes a receiving face that receives centrifugal force acting on the counter weight portion during use of the crankshaft.

5. The method according to claim 4, wherein the additional working process includes processing a shape of the shaft-side engaging portion such that the shaft-side engaging portion is at least one of inverted triangular shape, fan-shaped or sectoral, and T-shaped.

6. The method according to claim 3, wherein when the shaft portion provided with an even number of the pin portions and a plurality of the journal portions arranged in an axial direction of the shaft portion is formed in the stamping process, the shaft-side engaging portions are provided at opposite end portions of a centrally placed journal portion as one of the plurality of journal portions, and the shaft-side engaging portions are not provided at the journal portions located next to the centrally placed journal portion.

7. A crankshaft comprising:
a shaft portion including a pin portion and a journal portion, and including a shaft-side engaging portion;
a counter weight portion mounted on the shaft portion, and including a counter weight side engaging portion;
the shaft portion and the counter weight portion being integrated with each other, such that the shaft-side engaging portion engages with the counter weight side engaging portion; and
the shaft-side engaging portion including a receiving face that receives centrifugal force of the counter weight portion applied from the shaft portion in a radial direction.

8. The crankshaft according to claim 7, wherein a shape of the shaft-side engaging portion is at least one of inverted triangular shape, fan-shaped or sectoral, and T-shaped.
